(19) United States
(12) Patent Application Publication
(10) Pub. No.: US 2008/0185562 A1
(43) Pub. Date: Aug. 7, 2008

(54) Oxalate ester chemiluminescent light system

(75) Inventors: Yu Chen, Central (HK); Ning On, Central (HK)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Tianjin Dragon Chemiluminescent Tubes Co., Ltd., Tianjin (CN)

(21) Appl. No.: 12/012,368

(22) Filed: Feb. 1, 2008

(30) Foreign Application Priority Data
Feb. 7, 2007 (CN) 200710056751.5

(51) Int. Cl. C09K 11/00

(52) U.S. Cl. 252/700

(57) ABSTRACT

An embodiment of an oxalate ester chemiluminescent light system comprises two components. One component is an oxalate ester, containing at least 0.01M oxalate ester and 0.001M fluorescer in a suitable solvent; the other component contains 0.01M to 3M of hydrogen peroxide in a polyethylene glycol mixed solvent, where the amount of polyethylene glycol in the mixture is from 1%-99% and the balance of the mixed solvent may be an ester. In comparison to chemiluminescent light systems comprising tertiary alcohols, the light emitting system with the polyethylene glycol has lower toxicity, higher flash point and lower vapor pressure; the energy of the chemical light produced is about 15% higher; and storage stability is better.

### CROSS REFERENCE TO RELATED APPLICATION

This application claims benefit of Chinese Patent Application No. 200710056751.5, filed Feb. 7, 2007, which is incorporated herein by reference in its entirety.

### BACKGROUND

This invention relates to chemiluminescence, and especially to an oxalate ester chemiluminescent light system.

Various oxalate ester chemiluminescent light systems are known and used. A practical oxalate ester chemiluminescent light system should be able to produce a highly efficient chemical light, with good storage stability and safety. U.S. Pat. No. 4,313,843 describes in detail the principle of the formulation of the two reacting chemiluminescent components. A “hydrogen peroxide component” containing a tertiary alcohol is widely used. U.S. Pat. Nos. 4,678,608, 5,232,635, and among others describe variations in the oxalate chemiluminescent light system, but they continue to use the “hydrogen peroxide component” containing the tertiary alcohol described in U.S. Pat. No. 4,313,843.

However, this “hydrogen peroxide component” containing tertiary alcohol has poor storage stability, low light emission density, and other defects such as low flash point, high vapor pressure, and inferior safety.

Although tertiary alcohols have been preferred in use, numerous other possible solvents have been proposed. U.S. Pat. Nos. 3,576,987, 3,816,326, and 5,597,517 list various ethers and alcohols including 1,3-propylene glycol, dibutyl-diethylene glycol (believed to be dibutyl diethylene glycol ether), and diethylene glycol monobutyle ether.

### SUMMARY

There is a need for an oxalate ester chemiluminescent light system, with good storage stability and light emission features, as well as lower toxicity, higher flash point and lower vapor pressure than presently used systems containing tertiary alcohols.

According to one embodiment of the present invention, there is provided an oxalate ester chemiluminescent light system having the following features: it comprises two liquid components. A first liquid component, or “oxalate ester component,” comprises oxalate ester at concentrations of at least 0.01M and fluorescer at concentrations of at least 0.001M respectively. A second liquid component or hydrogen peroxide component” contains at least 0.01M to 3M hydrogen peroxide. The hydrogen peroxide is dissolved in a solvent mixture comprising from 1% to 99% by volume polyethylene glycol.

In the aforementioned hydrogen peroxide component, a catalyst in a concentration ranging from 10⁻⁵M to 10⁻¹M can be added. Suitable catalysts for embodiments of the present system include as sodium salicylate, tetrabutylammonium salicylate, potassium salicylate, lithium salicylate, sodium 5-chloro-salicylate, lithium 5-chloro-salicylate, sodium trifluoro acetate, potassium pentachlorophenolate, tetrabutylammonium benzoate, tetrabutylammonium perchlorate and combinations thereof.

The oxalate ester in the above-mentioned oxalate ester component is preferably at a concentration of at least 0.03M.

The oxalate ester in the above-mentioned oxalate ester component is preferably a phenol oxalate ester, most preferably a bis(substituted phenyl) oxalate ester, and is preferably selected from a group consisting of bis (2,4,5-trichloro-6-carbopentoxyphenyl) oxalate (“CPPO”) or bis (2,4,5-trichlorophenyl) oxalate (“TCPO”), bis (2,4,5-tribromo-6-carbohexoxyphenyl) oxalate, bis (2-nitrophenyl) oxalate, bis (2,4-dinitrophenyl) oxalate, bis (2,6-dichloro-4-nitrophenyl) oxalate, bis (2,4,6-trichlorophenyl) oxalate, bis (3-trifluoromethyl-4-nitrophenyl) oxalate, bis (1,2-dimethyl-4,6-dinitrophenyl) oxalate, bis (2.4-dichlorophenyl) oxalate, bis (2,4-dinitrophenyl) oxalate, bis (2,5-dinitrophenyl) oxalate, bis (2-formyl-4-nitrophenyl) oxalate, bis (pentachlorophenyl) oxalate, bis (1,2-dihydro-2-oxo-1-pyridyl) glyoxal, bis (2,4-dinitro-6-methylphenyl) oxalate, and combinations thereof.

The fluorescer is preferably present in a concentration of at least 0.002M in the above-mentioned oxalate ester component.

The fluorescer in the above-mentioned oxalate ester component is preferably selected from a group consisting of 9,10-diphenyl anthracene, 9,10-bis (phenylethynyl) anthracene, 1,8-dichloro-9,10-bis (phenylethynyl) anthracene, 2-ethyl-9,10-bis (phenyethynyl) anthracene, 1,6,7,12-tetraphenoxy-N,N′-bis (2,5-diisopropylphenl)-3,4,9,10-perylene dicarboximide, rubrene, and combinations thereof.

The oxalate ester component may include a solvent such as dibutyl phthalate, butyl benzoate, or ethyl benzoate.

The hydrogen peroxide in the above-mentioned hydrogen peroxide component is preferably in a concentration of at least 0.1 M.

The solvent in the polyethylene glycol/ester solution may consist essentially of the polyethylene glycol and the ester. Alternatively, other suitable solvents may be used instead of, or in addition to, the ester in the PEG mixed solvent.

The average molecular weight of the polyethylene glycol that is miscible with the hydrogen peroxide in the polyethylene glycol/ester solution is preferably in the range from 200-700, forming a viscous liquid at room temperature. The said ester is preferably selected from ethyl acetate, dimethyl phthalate, methyl salicylate, ethyl salicylate, tributyl citrate, glycerol triacetate, and combinations thereof.

The polyethylene glycol content in the above-mentioned polyethylene glycol ester mixed solution can be preferably from about 3% to about 30% by volume.

It is to be understood that both the foregoing general description and the following detailed description are exemplary and explanatory and are intended to provide further explanation of the invention as claimed.

### DETAILED DESCRIPTION

Reference will now be made in detail to various embodiments of the present invention. The embodiments are described by way of explanation, and not by way of limitation.

In an embodiment of an oxalate ester chemiluminescent light system, there are provided two liquid components, which are kept separate until it is desired to produce light. One liquid component is an oxalate ester component comprising at least 0.01M, preferably at least 0.3M of oxalate ester and at least 0.001M, preferably at least 0.002M, of fluorescer. The other liquid component is a hydrogen peroxide component comprising 0.01M to 3M, preferably at least 0.1M, hydrogen peroxide dissolved in a mixture of polyethylene glycol and ester, wherein the proportion of polyethylene glycol in the mixture is in the range from 1%-99%, preferably from about 3% to about 30%.

The hydrogen peroxide component in this embodiment further comprises from 10⁻⁵M to 10⁻¹M of a catalyst selected from sodium salicylate, tetrabutylammonium salicylate, potassium salicylate, lithium salicylate, sodium 5-chloro-salicylate, lithium 5-chloro-salicylate, sodium trifluoro acetate, potassium pentachlrophenolate, tetrabutylammonium benzoate, tetrabutylammonium perchlorate, and mixtures thereof.

The oxalate ester in this embodiment is selected from the group consisting of bis (2,4,5-trichloro-6-carbopentoxyphenyl) oxalate (“CPPO”) or bis (2,4,5-trichlorophenyl) oxalate (“TCPO”), bis (2,4,5-tribromo-6-carbohexoxyphenyl) oxalate, bis (2-nitrophenyl) oxalate, bis (2,4-dinitrophenyl) oxalate, bis (2,6-dichloro-4-nitrophenyl) oxalate, bis (2,4,6-trichlorophenyl) oxalate, bis (3-trifluoromethyl-4-nitrophenyl) oxalate, bis (1,2-dimethyl-4,6-dinitrophenyl) oxalate, bis (2.4-dichlorophenyl) oxalate, bis (2,4-dinitrophenyl) oxalate, bis (2,5-dinitrophenyl) oxalate, bis (2-formyl-4-nitrophenyl) oxalate, bis (pentachlorophenyl) oxalate, bis (1,2-dihydro-2-oxo-1-pyridyl) glyoxal, bis (2,4-dinitro-6-methylphenyl) oxalate, and mixtures thereof.

The fluorescer in the above-mentioned oxalate ester component in this embodiment is selected from a group consisting of 9,10-diphenyl anthracene, 9,10-bis (phenylethynyl) anthracene, 1,8-dichloro-9,10-bis (phenylethynyl) anthracene, 2-ethyl-9,10-bis (phenyethynyl) anthracene, 1,6,7,12-tetraphenoxy-N,N′-bis (2,5-diisopropylphenl)-3,4,9,10-perylene dicarboximide, rubrene, and mixtures thereof.

The oxalate ester component includes a solvent selected from dibutyl phthalate, butyl benzoate, ethyl benzoate, and combinations thereof.

The average molecular weight of the polyethylene glycol (PEG) is in the range from 200 to 700. At room temperature the PEG is a viscous liquid. The ester in the polyethylene glycol ester mixed solution in this embodiment is selected from ethyl acetate, dimethyl phthalate, methyl salicylate, ethyl salicylate, tributyl citrate, glycerol triacetate, and mixtures thereof.

The following examples illustrate the invention.

### EXAMPLE 1

Add 20 ml of polyethylene glycol—400 to 80 ml of dimethyl phthalate, whilst stirring, add 6 ml of 85% hydrogen peroxide and 0.01 g. sodium salicylate, continue stirring until the sodium salicylate is completely dissolved. The resultant solution is called the “hydrogen peroxide component.”

Take 100 ml of dibutyl phthalate, add 10 g. CPPO, heat to 150° C., purged with nitrogen gas, add 0.13 g. 9,10-bis(phenylethynyl) anthracene, continue stirring until the dissolution is complete. The resultant solution is called the “oxalate ester component.”

Take 3 parts of the “oxalate ester component”, add to it 1 part of the “hydrogen peroxide component”, shake well and a bright green light is produced.

### EXAMPLE 2

Add 30 ml of polyethylene glycol—400 to 70 ml of ethyl acetate, whilst stirring add 6 ml of 85% hydrogen peroxide, continue stirring and the resultant solution is the “hydrogen peroxide component.”

Take 100 ml dibutyl phthalate, add 10 g. CPPO, heat to 150° C., purged with nitrogen gas, add 0.13 g. 9,10-bis (phenylethynyl) anthracene, continue stirring until dissolution is complete. The resultant solution is called the “oxalate ester component”.

Take 3 parts of the “oxalate ester component”, add 1 part of the “hydrogen peroxide component”, shake well and a bright green light is produced.

It is possible to achieve the following advantages with systems mentioned in the present application or otherwise in accordance with the present invention.

First, polyethylene glycol exhibits lower toxicity, higher flash point and lower vapor pressure than does the presently used tertiary alcohol. Consequently, the described systems, when compared the conventional chemiluminescent light systems using tertiary alcohol, can also exhibit lower toxicity, higher flash point and lower vapor pressure. In more detail:

The flash point of some conventional chemiluminescent light systems with tertiary alcohol is 20-30° C. In contrast, the flash point of the formulation with polyethylene glycol can be >95° C., and can be around 200° C. depending on the molecular weight of the PEG.

The toxicity of the tertiary alcohol used in the formulation of many conventional chemiluminescent light systems, measured as LD50 in rats for oral administration, is 3,000-4,000 mg/kg, whilst the LD50 in rats of the polyethylene glycol used in the present formulations is 30,000-50,000 mg/kg.

The tertiary alcohol used in many conventional chemiluminescent light systems boils at 70-80° C., whilst the present chemiluminescent light system can be formulated using a polyethylene glycol that has a vapor pressure of only 0.4 to 0.01 kPa at 100° C.

Second, the energy of the chemiluminescent light produced by the presently described formulations can be about 15% greater than that of some conventional chemiluminescent light systems with tertiary alcohol.

Third, the present chemiluminescent light system can have better storage stability than many chemiluminescent light systems with tertiary alcohol. Following one year of storage, the deterioration range of the light energy of some of the presently proposed formulations can be as little as 50% of the deterioration of the conventional chemiluminescent light systems, thereby significantly increasing the shelf life and utilization performance following storage.

The following Table summarizes some of the differences in properties between PEG and some of the previously proposed solvents:

| | | 1,3-propylene | dibutyl diethylene | |
|---|---|---|---|---|
| | PEG | glycol | glycol ether | tertiary alcohol |
| Flash point (° C./° F.) | ~200/392, depending on | 79/174 | 117/243 | 20/70-30/85 |
| | molecular weight | | | |
| Toxicity (LD50 oral, | 28,900 (mus) | 4,770 (mus) | 3,900 (rat) | 3,000-4,000 (rat) |
| mg/kg) | | | | |
| Vapor pressure (kPa) | PEG300 - 0.3866 at 100° C. | 1.33 at 100° C. | 1.33 at 122° C. | Boils at |
| | PEG 400 - 0.012 at 100° C. | | | 70° C.-80° C. |
| | PEG 600 - 0.0069 at 100° C. | | | |
| Irritant effect | Basically none | May irritate eyes | May irritate eyes, skin, | |
| | | and skin | mucous membranes | |

Various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A two-component chemiluminescent light system, comprising:
a first liquid component that comprises at least 0.01M oxalate ester and at least 0.001M fluorescer; and
a second liquid component that comprises 0.01M to 3M hydrogen peroxide, the hydrogen peroxide dissolved in a solvent mixture comprising from 1% to 99% by volume polyethylene glycol.

2. The chemiluminescent light system according to claim 1, wherein the second liquid component further comprises at least one catalyst selected from sodium salicylate, tetrabutylammonium salicylate, potassium salicylate, lithium salicylate, sodium-5-chlorosalicylate, lithium-5-chlorosalicylate, sodium trifluoroacetate, potassium pentachlorophenolate, tetrabutylammonium benzoate, tetrabutyl ammonium perchlorate, and combinations thereof in a concentration in the range from 10⁻⁵ to 10⁻¹ M.

3. The chemiluminescent light system according to claim 1, wherein said first liquid component comprises at least 0.03M of said oxalate ester.

4. The chemiluminescent light system according to claim 1, wherein said oxalate ester in said first liquid component is selected from a group consisting of bis (2,4,5-trichloro-6-carbopentoxyphenyl) oxalate, bis (2,4,5-trichlorophenyl) oxalate, bis (2,4,5-tribromo-6-carbohexoxyphenyl) oxalate, bis (2-nitrophenyl) oxalate, bis (2,4-dinitrophenyl) oxalate, bis (2,6-dichloro-4-nitrophenyl) oxalate, bis (2,4,6-trichlorophenyl) oxalate, bis (3-trifluoromethyl-4-nitrophenyl) oxalate, bis (1,2-dimethyl-4,6-dinitrophenyl) oxalate, bis (2.4-dichlorophenyl) oxalate, bis (2,4-dinitrophenyl) oxalate, bis (2,5-dinitrophenyl) oxalate, bis (2-formyl-4-nitrophenyl) oxalate, bis (pentachlorophenyl) oxalate, bis (1,2-dihydro-2-oxo-1-pyridyl) glyoxal, bis (2,4-dinitro-6-methylphenyl) oxalate, and combinations thereof.

5. The chemiluminescent light system according to claim 1, wherein said first liquid component comprises at least 0.002M of said fluorescer.

6. The chemiluminescent light system according to claim 1, wherein said fluorescer in said oxalate ester component is selected from a group consisting of 9,10-diphenyl anthracene; 9,10-bis (phenylethynyl) anthracene; 1,8-dichloro-9,10-bis (phenylethynyl) anthracene; 2-ethyl-9,10-bis (phenylethynyl) anthracene; 1,6,7,12-tetraphenoxy-N,N′-bis (2,5-diisopropylphenl)-3,4,9,10-perylene dicarboximide; rubrene; and combinations thereof.

7. The chemiluminescent light system according to claim 1, wherein said second liquid component comprises at least 0.1 M of said hydrogen peroxide.

8. The chemiluminescent light system according to claim 1, wherein the average molecular weight of said polyethylene glycol in said second liquid component is in the range from 200 to 700.

9. The chemiluminescent light system according to claim 8, wherein the polyethylene glycol content in the solvent mixture is from about 3% to about 30% by volume.

10. The chemiluminescent light system according to claim 1, wherein said polyethylene glycol is a viscous liquid at room temperature.

11. The chemiluminescent light system according to claim 1, wherein said solvent mixture further comprises an ester.

12. The chemiluminescent light system according to claim 11, wherein said ester in said solvent mixture is selected from a group consisting of ethyl acetate, dimethyl phthalate, methyl salicylate, ethyl salicylate, tributyl citrate, glycerol triacetate, and combinations thereof.
